(19) United States
(12) Patent Application Publication
(10) Pub. No.: US 2012/0160053 A1
(43) Pub. Date: Jun. 28, 2012

(54) ADJUSTABLE MOTORCYCLE LEVER

(76) Inventor: Charlie Hon, Pomona, CA (US)

(21) Appl. No.: 12/975,372

(22) Filed: Dec. 22, 2010

(51) Int. Cl. G05G 1/04

(52) U.S. Cl. 74/522

(57) ABSTRACT

An improved, adjustable hand-operated motorcycle lever is disclosed for actuating hydraulic motorcycle braking and clutching mechanisms. The adjustable lever comprises, inter alia, a base member, a proximal member, a center member, a distal member, an actuator nut, and a barrel component. The lever is easily adjustable to accommodate the hand sizes of different riders, and can be laterally adjusted to augment or reduce leverage to a motorcycle rider.

### BACKGROUND OF THE INVENTION

1. Field of the Invention

This invention relates to vehicle clutch and brake actuation mechanisms, and more particularly relates to adjustable motorcycle clutch and brake levers.

2. Description of the Related Art

Motorcycle clutch and braking systems, clutch and brake actuation mechanisms, and clutch and brake levers are well-known in the art. Traditional levers in the art comprise rigid elongated levers, or cantilevers, which are pivotably connected to handlebars, a chassis, or the like. Traditional brake levers are detachably connected to a Bowden cable, which clenches brake arms and force brake pads against a braking surface to slow a motorcycle. More recent developments in the art include hydraulic brake levers and disc brakes. Hydraulic brake levers force pressurized braking fluid through hoses to activate motorcycle brakes and slow the vehicle.

Some clutch and brake levers are difficult for smaller riders to reach while steering and effectively grip while the motorcycle is in motion. Although there exist clutch and brake levers known in the art which are designed to accommodate female riders, and riders with smaller hands, traditional levers known cannot be effortlessly readjusted to accommodate riders with differing grip and hand sizes, which is necessary if multiple riders are using the same motorcycle. Traditional levers cannot be shortened or elongated to add leverage for riders of different strengths. Additionally, traditional levers are not modularized such that damaged portions of the lever can be replaced independently of the entire clutch or brake lever, which may be necessary after a motorcycle falls or impacts with a ground surface. Furthermore, traditional levers are not modularized such that upon crash impact, the lever can axially rotate around an axis other than the axis around which the level pivots to avoid breakage of the lever itself

It is therefore desirable that an adjustable, modularized, hydraulic brake/clutch lever which is aesthetically pleasing be provided.

### SUMMARY OF THE INVENTION

From the foregoing discussion, it should be apparent that a need exists for an improved, adjustable motorcycle lever for braking or clutching. Beneficially, such a lever would overcome many of the difficulties with prior art by providing a means for easily readjusting the brake lever to alternately serve riders of different hand sizes.

The present invention has been developed in response to the present state of the art, and in particular, in response to the problems and needs in the art that have not yet been fully solved by currently available brake actuation systems. Accordingly, the present invention has been developed to provide an improved, adjustable hand-operated motorcycle lever comprising: a base member comprising a generally planar plate fabricated from one or more of metals, alloys and polymers, the plate coupled to an elongated, hollow, generally cylindrical metallic member, wherein a longitudinal axis of the brake lever extends through the hollow length of the metallic member, wherein the metallic member is affixed to a generally l-shaped metal plate, a portion of which juts outwardly in cantilever fashion along the longitudinal axis for actuating a hydraulic brake system.

The improved, adjustable hand-operated lever also comprises a proximal member, pivotably connected to the base member at a joint, comprising a metallic, generally planar plate with a top surface and a bottom surface, the proximal member forming a recess for housing an actuator nut.

The actuator nut is rotatably affixed within the proximal member, the actuator nut housing a shaft-like gear member extendable and retractable with manual adjustment of the actuator nut, which gear member is in physical contact with the base member, such that when the gear member is extended, the proximal member is pivoted away from the base member to accommodate a motorcycle rider with larger hands.

The improved, adjustable hand-operated lever also comprises an elongated center member hingedly connected to the proximal member at a joint. The center member comprises a metallic, generally planar plate with a planar top surface and a planar bottom surface, which center member generally tapers from the point of abutment with the proximal member to an opposing point more distantly separated from the actuator nut on a lateral axis orthogonal to the longitudinal axis.

The improved, adjustable hand-operated lever also comprises an elongated distal member slidably connected to the center member such that the distal member can be extended and refracted laterally relative to the center member, the distal member comprising an aperature traversing the distal member longitudinally.

In some embodiments, the brake lever further comprises a padded polymer grip made spanning a forward edge of the center member. In some embodiments, the base plate, proximal member, center member, and distal member all are formed from one of titanium, aluminum, stainless steel, and brass.

In still further embodiments, the improved, adjustable motorcycle lever further comprises a spring affixed at one end the base plate and affixed at another end to the proximal member such that the spring presses the gear member against the base member.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 shows a top perspective view of an improved brake/cluth lever 100 in accordance with the present invention;

FIG. 2A shows an inner elevational perspective view of the improved brake/clutch lever in accordance with the present invention;

FIG. 2B shows an exploded view of the joint of an improved brake/clutch lever in accordance with the present invention 1;

FIG. 3 shows an outer elevational perspective view of an improved brake/clutch lever in accordance with the present invention; and

FIG. 4 shows a front perspective view of the improved brake/clutch lever in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

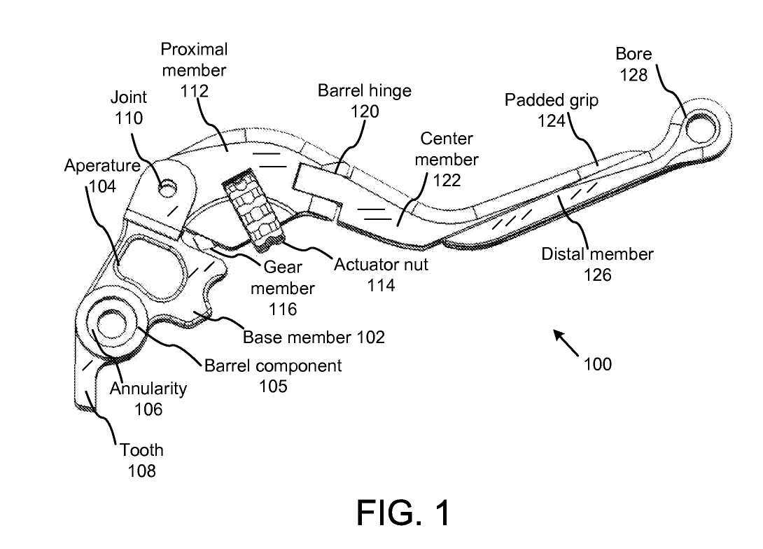

FIG. 1 shows a top perspective view of an improved brake/clutch lever 100 in accordance with the present invention. The improved brake lever 100 comprises four principal members: a base member 102, a proximal member 112, a center member 122, and a distal member 126. Each member comprises various subcomponents, including an aperature 104, a barrel component 105, an annularity 106, a cantilever or tooth 108, a joint 110, an actuator nut 114, a gear member 116, a barrel hinge 120, a padded grip 124, and a bore 128.

The base member 102 may be formed from any number of rigid materials well known to those of skill in the art, including polymers, iron, stainless steel, titanium, aluminum, brass, wood, stone, polymers, and the like. The base member 102 comprises a generally planar plate fabricated from one or more metals, alloys and/or polymers which is between one millimeter and six centimeters thick.

The base member 102 is attachable and detachable to a motorcycle chassis, frame, handlebar assembly, and the like. In the shown the embodiment, the base member 102 activates a hydraulic brake or clutch system vis-à-vis the tooth 108. In other embodiments, the base member 102 may be configured to work with a Bowden cable and the like.

The base member 102 may be coupled, formed to, molded with, or fabricated with, an elongated, hollow, generally cylindrical metallic barrel member 102.

The barrel component 105 comprises a tubular, cylindrical, or barrel-like component permanent affixed to, or forming part of, the base member 102. The barrel component 105 may be fabricated via welding, machining, laser sintering, and the like. The barrel component 105 may be manufactured as part of the base member 102.

In some embodiments, the lever 100 is affixed to the motorcycle by bolting the lever 100 onto the motorcycle handlebars with a bolt that traverses the hollow recess of the barrel component 105. The lever 100 then rotates, or pivots, around the bolt from one to fifty degrees.

The annularity 106 and/or the barrel component 105 detachably connect to the handle bars and/or other components of the braking/clutching mechanism of a motorcycle (not shown).

A longitudinal axis runs through the hollow portion of the barrel member 102 and traverses the brake lever 100. The base member comprises, and is affixed to, a generally l-shaped metal plate, a portion of which juts outwardly in cantilever fashion along the longitudinal axis for actuating a hydraulic brake system.

In some embodiments, the base member 102 comprises one or more holes, bores, or aperatures 104 for reducing weight and saving raw materials necessary to construct the brake lever 100.

The proximal member 112 is pivotably connected to the base member at a joint 110. The proximal member 112 comprises a metallic, generally planar plate with a top surface and a bottom surface, the proximal member forming a recess for housing an actuator nut 114.

The actuator nut 114 is rotatably affixed within the proximal member 112. The actuator nut 114 housing a shaft-like gear member 116 extendable and retractable with manual adjustment of the actuator nut 114. The actuator nut 114 can be turned manually by a motorcycle rider to extend or retract the gear member 116. When the gear member 116 is in physical contact with the base member 102, the gear member forces the proximal member 112 away from the handlebars disposed roughly parallel to the breadth of the lever 100 such that when the gear member 116 is extended, the proximal member 112 is pivoted away from the base member 102 to accommodate a motorcycle rider with larger hands.

The actuator nut 114 gear may comprise any type of manual linear actuator, including any type of gear commonly known to those of skill in the art, including a worm gear, a spiral gear, a helical gear, spur gear, rack and pinion, screw jack, ball screw, roller screw, and the like.

The barrel hinge 120 comprises a hinge connecting the proximal member 112 to the center member 122. The barrel hinge 120 allows the center member 122 and the distal member 126 to axially rotate with around the proximal member 112 when impact to avoid breakage of the lever itself. Because the barrel hinge 120 allows axial rotation around an axis that is orthogonal to the direction of pull of a user activating the lever 100, it does not interfere with user braking or clutching.

In some embodiments, the barrel hinge 120 comprises a torsion spring, or another type of spring well-known to those of skill in the art, that biases the barrel hinge 120 into its shown position in which the center member 122 and proximal member 112 share a plane with each other. In other embodiments, the screw traverses the barrel hinge 120 can be tightened to adjust the torque that must applied to the barrel hinge 120 to for the barrel hinge 120 to break from its shown position.

The center member 122 comprises an elongated component hingedly connected to the proximal member 112 at a joint, comprising a metallic, generally planar plate with a planar top surface and a planar bottom surface, which center member 122 generally tapers from the point of abutment with the proximal member 112 to an opposing point more distantly separated from the actuator nut 114 on a lateral axis orthogonal to the longitudinal axis.

The distal member 126 comprises an elongated component separated from the center member 122 along the lateral axis and slidably connected to the center member 122 such that the distal member 126 can be extended and retracted laterally relative to the center member 122, the distal member 126 comprising an aperature traversing the distal member 126 longitudinally.

The brake lever 100 may comprised a padded polymer grip 124 spanning a forward edge of the center member 122. The padded grip 124 may be made from memory foam, silicone gel, inflated bladders or balloon, and the like. The padded grip 124 may be inflatable.

The base plate 102, proximal member 112, center member 122, and distal member 126 may are formed from one of titanium, aluminum, stainless steel, and brass.

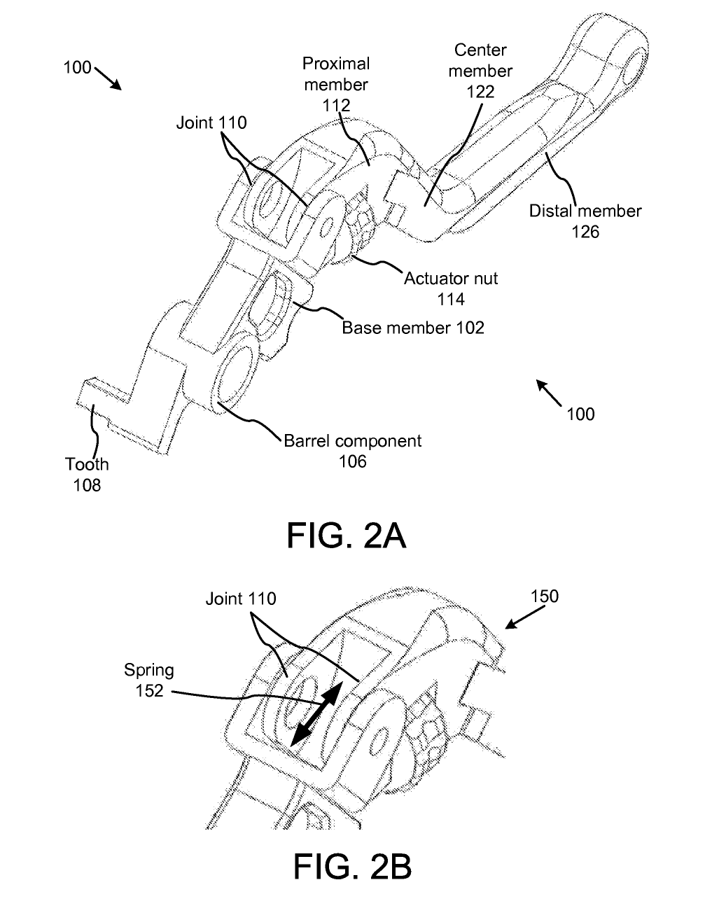

FIG. 2A shows an inner elevational perspective view of the improved brake/clutch lever 100 in accordance with the present invention. Shown are the base member 102, the barrel component, 106, the tooth 108, the joint 110, proximal member 112, and actuator nut 114, center member 122, and distal member 126.

FIG. 2A shows an alternative perspective view of the brake lever 100. Each of the components shown in FIG. 2 is substantially described above in relation to FIG. 1.

FIG. 2B shows an exploded view of the joint 110 section of an improved brake/clutch lever 150 in accordance with the present invention. Shown are the joint 110 and the spring 152.

The join 110 is substantially described above in relation to FIG. 1.

In some embodiments of the present invention, the brake/clutch lever 150 comprises a spring 152 affixed at one end the base member 102 and affixed at its opposing end to the proximal member 112. The spring 152 may be configured to pull the base member 102 and the proximal member 112 together, thus pressing the gear member 116 against the base member 102, but allowing for the proximal member 112 and its appendages to rotate axially around the joint 110 if forced in that direction by the ground or another object impacting with the lever 150.

The spring 152 may comprise a helical spring, a volute spring, a spiral torsion spring, a gas spring, flat spring, and the like. The spring 152 may fixed anywhere in or near the joint 110 provided that the spring 152 interconnects, or is mutually attached to, both the base member 102 and the proximal member 112.

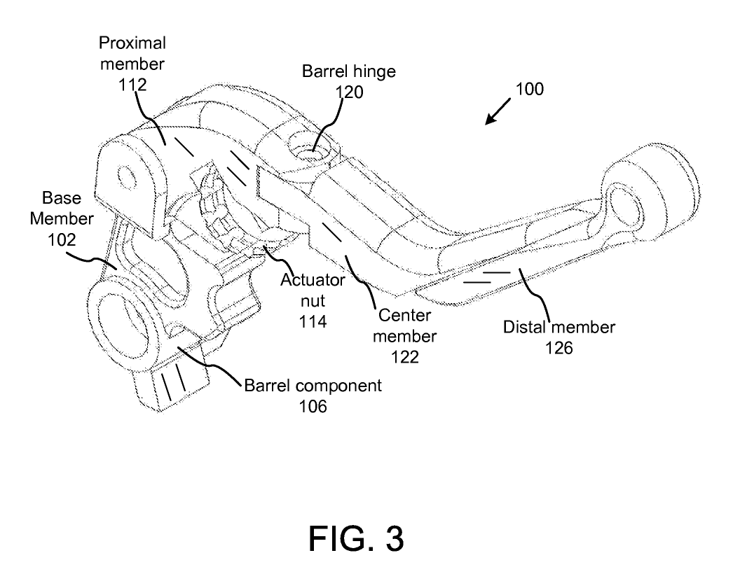

FIG. 3 shows an outer elevational perspective view of the improved brake/clutch lever 100 in accordance with the present invention. Shown are the base member 102, the barrel component 106, the proximal member 112, the actuator nut 114, the barrel hinge 120, the center member 122, and the distal member 126. Each are substantially described above in relation to FIGS. 1-3.

FIG. 3 shows an alternative perspective view of the brake lever 100.

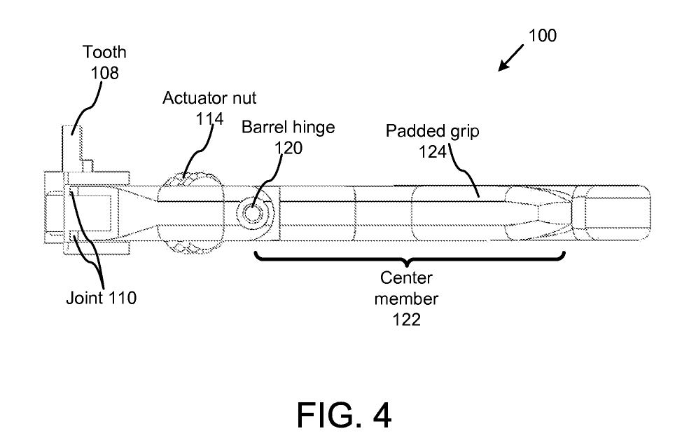

FIG. 4 shows a front perspective view of the improved brake/clutch lever 100 in accordance with the present invention. Shown are the tooth 108, the joint 110, the actuator nut 114, the barrel hinge 120, the center member 122, and the padded grip 124. Each are substantially described above in relation to FIGS. 1-3.

FIG. 4 shows an alternative perspective view of the brake lever 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An improved, adjustable motorcycle lever comprising:
a base member comprising a generally planar plate fabricated from one or more of metals, alloys and polymers, the plate coupled to an elongated, hollow, generally cylindrical metallic member, wherein a longitudinal axis of the brake lever extends through the hollow length of the metallic member, wherein the metallic member is affixed to a generally l-shaped metal plate, a portion of which juts outwardly in cantilever fashion along the longitudinal axis for actuating a hydraulic brake system;
a proximal member, pivotably connected to the base member at a joint, comprising a metallic, generally planar plate with a top surface and a bottom surface, the proximal member forming a recess for housing an actuator nut;
the actuator nut rotatably affixed within the proximal member, the actuator nut housing a shaft-like gear member extendable and retractable with manual adjustment of the actuator nut, which gear member is in physical contact with the base member, such that when the gear member is extended, the proximal member is pivoted away from the base member to accommodate a motorcycle rider with larger hands;
an elongated center member hingedly connected to the proximal member at a joint, comprising a metallic, generally planar plate with a planar top surface and a planar bottom surface, which center member generally tapers from the point of abutment with the proximal member to an opposing point more distantly separated from the actuator nut on a lateral axis orthogonal to the longitudinal axis; and
an elongated distal member slidably connected to the center member such that the distal member can be extended and retracted laterally relative to the center member, the distal member comprising an aperature traversing the distal member longitudinally.

2. The improved, adjustable motorcycle lever of claim 1, further comprising a padded polymer grip made spanning a forward edge of the center member.

3. The improved, adjustable motorcycle lever of claim 1, wherein the base plate, proximal member, center member, and distal member all are formed from one of titanium, aluminum, stainless steel, and brass.

4. The improved, adjustable motorcycle lever of claim 1, further comprising a spring affixed at one end the base plate and affixed at another end to the proximal member such that the spring presses the gear member against the base member.
